(19) United States
(12) Patent Application Publication
(10) Pub. No.: US 2003/0231085 A1
(43) Pub. Date: Dec. 18, 2003

(54) Transmission line type noise filter with small size and simple structure, having excellent noise removing characteristic over wide band including high frequency band

(75) Inventors: Satoshi Arai, Sendai-shi (JP); Takayuki Inoi, Sendai-shi (JP); Yoshihiko Saiki, Sendai-shi (JP); Sadamu Toita, Sendai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NEC TOKIN Corporation, Sendai-shi (JP)

(21) Appl. No.: 10/458,918

(22) Filed: Jun. 10, 2003

(30) Foreign Application Priority Data
Jun. 11, 2002 (JP) 169923/2003

(51) Int. Cl. H01P 1/205

(52) U.S. Cl. 333/204

(57) ABSTRACT

A noise filter (1) has a first impedance element (2) having an impedance value Z1, a second impedance element (3) having an impedance value Z2, a third impedance element (4) having an impedance value Z3, a first anode terminal (5), a second anode terminal (6), and a cathode terminal (7). Z1<Z2 and Z1<Z3 are satisfied. Both ends of a central conductor (2a) of the first impedance element (2) are connected to a first node (8) and a second node (9), respectively. Both ends of the second impedance element (3) are connected to the first node (8) and the first anode terminal (5), respectively. Both ends of the third impedance element (4) are connected to the second anode terminal (6) and the second node (9), respectively. The central conductor (2a) and a cathode conductor (2b) of the first impedance element (2) form a transmission line structure having the impedance value Z1. The cathode conductor (2b) is connected to the cathode terminal (7).

This application claims priority to prior application JP 2002-169923, the disclosure of which is incorporated herein by reference.

### BACKGROUND OF THE INVENTION

The present invention relates to a noise filter that is mounted in an electronic device or electronic equipment for removing noise generated therein.

Digital technologies are important technologies supporting IT (Information Technology) industries. Recently, digital circuit technologies such as LSI (Large Scale Integration) have been used in not only computers and communication-related devices, but also household electric appliances and vehicle equipment.

High-frequency noise currents generated in LSI chips or the like do not stay in the neighborhood of the LSI chips but spread over wide ranges within mounting circuit boards such as printed circuit boards, and are subjected to inductive coupling in signal wiring or ground wiring, thereby leaking from signal cables or the like as electromagnetic waves.

In those circuits each including an analog circuit and a digital circuit, such as a circuit in which part of a conventional analog circuit is replaced with a digital circuit, or a digital circuit having analog input and output, electromagnetic interference from the digital circuit to the analog circuit has been becoming a serious problem.

As a countermeasure therefor, a technique of power supply decoupling is effective in which an LSI chip as a source of generation of high-frequency current is separated from a dc power supply system in terms of high frequencies. Noise filters such as bypass capacitors have been used hitherto as decoupling elements, and the operation principle of the power supply decoupling is simple and clear.

The capacitors as noise filters used in conventional ac circuits form two-terminal lumped constant noise filters, and solid electrolytic capacitors, electric double-layer capacitors, ceramic capacitors or the like are often used therefor.

When carrying out removal of electrical noise in an ac circuit over a wide frequency band, inasmuch as a frequency band that can be dealt with by one capacitor is relatively narrow, different kinds of capacitors, for example, an aluminum electrolytic capacitor, a tantalum capacitor and a ceramic capacitor having different self-resonance frequencies, are provided in the ac circuit.

Conventionally, however, it has been bothersome to select and design a plurality of noise filters that are used for removing electrical noise of a wide frequency band. In addition, there has been a problem that, because of using different kinds of the noise filters, the cost is high, the size is large, and the weight is heavy.

Further, as described above, for dealing with higher-speed and higher-frequency digital circuits, there have been demanded those noise filters that can ensure decoupling over a high frequency band and exhibit low impedances even in the high frequency band.

However, the two-terminal lumped constant noise filters have difficulty in maintaining low impedances up to the high frequency band due to self-resonance phenomena of capacitors, and thus are inferior in performance of removing high-frequency band noise.

Further, the electronic equipment or devices with the LSI chips or the like mounted therein have been required to be further reduced in size, weight and cost. Therefore, the noise filters that are used in those electronic equipment or devices have also been required to be further reduced in size, to be structured more simply, and to be manufactured more easily.

### SUMMARY OF THE INVENTION

Therefore, it is an object of the present invention to provide a transmission line type noise filter that is excellent in noise removing characteristic over a wide band including a high frequency band and that has a small size and a simple structure.

A transmission line type noise filter according to the present invention is a transmission line type noise filter connectable between an electrical load component and a power supply for attenuating a coming alternating current while passing a coming direct current, and comprising a first anode terminal connected to the electrical load component; a second anode terminal connected to the power supply; a first impedance element having a transmission line structure; and a second impedance element having an impedance value greater than an impedance value of the first impedance element, and connected between one end of the first impedance element and the first anode terminal, in which the other end of the first impedance element is connected to the second anode terminal.

Another transmission line type noise filter according to the present invention is a transmission line type noise filter connectable between an electrical load component and a power supply for attenuating a coming alternating current while passing a coming direct current, and comprising a first anode terminal connected to the electrical load component; a second anode terminal connected to the power supply; a first impedance element having a transmission line structure; a second impedance element having an impedance value greater than an impedance value of the first impedance element, and connected between one end of the first impedance element and the first anode terminal; and a cathode terminal connected to a fixed potential, in which the other end of the first impedance element is connected to the second anode terminal, the first impedance element comprises a first conductor and a second conductor confronting the first conductor, the transmission line structure is formed in a region where the first conductor and the second conductor are disposed confronting each other, and has a rectangular shape in plan view, and a length of the first conductor in a first direction parallel to a line of the transmission line structure, a length of the first conductor in a second direction perpendicular to the first direction, and an effective thickness are set so that the impedance value of the first impedance element becomes smaller than the impedance value of the second impedance element, one end of the first conductor in the first direction is connected to the second impedance element, while the other end thereof is connected to the second anode terminal, and the second conductor is connected to the cathode terminal.

Other objects, features and advantages of the present invention will become apparent from the following description of this specification.

### BRIEF DESCRIPTION OF THE DRAWINGS

FIG. 1 is an exemplary diagram showing a schematic structure of a preferred embodiment of a transmission line type noise filter of the present invention;

FIGS. 2A to 2C are diagrams showing a transmission line type noise filter according to a first preferred embodiment of the present invention, in which FIG. 2A is an exemplary plan view, FIG. 2B is a sectional view taken along line A-A′ of FIG. 2A, and FIG. 2C is a sectional view taken along line B-B′ of FIG. 2A;

FIG. 3 is a diagram showing a transmission line model of a first impedance element in the transmission line type noise filter of the present invention;

FIG. 4 is an exemplary plan view showing a transmission line type noise filter according to a second preferred embodiment of the present invention;

FIGS. 5A to 5C are diagrams showing a transmission line type noise filter according to a third preferred embodiment of the present invention, in which FIG. 5A is an exemplary plan view, FIG. 5B is a sectional view taken along line E-E′ of FIG. 5A, and FIG. 5C is an exemplary sectional perspective view showing a structure of one electric double-layer cell included in an electric double-layer capacitor;

FIG. 6A is an exemplary diagram showing one example in which a transmission line type noise filter of the present invention has a four-terminal structure; and

FIG. 6B is an exemplary diagram showing another example in which a transmission line type noise filter of the present invention has a four-terminal structure.

### DESCRIPTION OF THE PREFERRED EMBODIMENTS:

Now, transmission line type noise filters according to preferred embodiments of the present invention will be described hereinbelow with reference to the drawings.

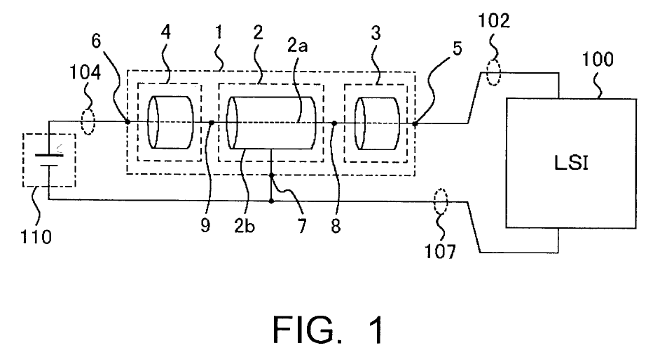

FIG. 1 is an exemplary diagram showing a schematic structure of a preferred embodiment of a transmission line type noise filter of the present invention, and shows the state in which the noise filter of this embodiment is interposed between an electronic component and a power supply that drives the electronic component.

Referring to FIG. 1, a noise filter 1 of this embodiment comprises a first impedance element 2 having an impedance value Z1, a second impedance element 3 having an impedance value Z2, a third impedance element 4 having an impedance value Z3, a first anode terminal 5, a second anode terminal 6, and a cathode terminal 7. The noise filter 1 satisfies Z1<Z2 and Z1<Z3 in a frequency region higher than a predetermined frequency Fm.

The first impedance element 2 comprises a central conductor 2a and a cathode conductor 2b.

Both ends of the central conductor 2a of the first impedance element 2 are connected to a first node 8 and a second node 9, respectively, both ends of the second impedance element 3 are connected to the first node 8 and the first anode terminal 5, respectively, and both ends of the third impedance element 4 are connected to the second anode terminal 6 and the second node 9, respectively.

Further, the cathode conductor 2b of the first impedance element 2 is connected to the cathode terminal 7.

The central conductor 2a and the cathode conductor 2b of the first impedance element 2 form a transmission line structure having the impedance value Z1.

The noise filter 1 has the first anode terminal 5 connected to a high-potential side power input terminal of an electronic component such as an LSI 100 via a first power line 102, the second anode terminal 6 connected to a high-potential side output terminal of a dc power supply 110 via a second power line 104, and the cathode terminal 7 connected to a low-potential side power line (hereinafter referred to as “ground line”) providing connection between a low-potential side output terminal of the dc power supply 110 and a low-potential side power input terminal of the LSI 100.

Now, an operation of the transmission line type noise filter of the present invention will be described using an operation of the noise filter 1 as an example.

The LSI 100 causes generation of noise on the first power line 102 following an operation thereof.

The generated noise is transmitted through the first power line 102, but part of it is reflected by the high-impedance second impedance element 3, disposed on the side of the first anode terminal 5, of the noise filter 1 and returned to the side of the LSI 100.

The residual noise invades the inside of the noise filter 1 via the second impedance element 3, but most of it is led to the ground line 107 via the cathode terminal 7 by means of the low-impedance first impedance element 2, bypassing the second power line 104 etc., and thus returned to the LSI 100 likewise.

In this manner, the noise transmitted to the side of the second power line 104 is attenuated to a slight amount.

The foregoing operation is a basic feature of the transmission line type noise filter according to the present invention. However, the present invention may further comprise the third impedance element 4.

The noise that has even passed through the first impedance element 2 and reached the second node 9 is reflected by the high-impedance third impedance element 4 disposed between the second node 9 and the second anode terminal 6 and returned to the first impedance element 2 so as to be further returned from the first impedance element 2 to the side of the LSI 100.

In this manner, the noise transmitted to the side of the second power line 104 is attenuated to an extremely slight amount.

Inasmuch as the present noise filter is of the transmission line type, it is possible to remove noise of a wide frequency band with high accuracy without providing a plurality of noise filters (capacitors) having different self-resonance frequencies as in the conventional technique. That is, it is not necessary to perform a laborsome operation of setting frequency bands to capacitors disposed in an ac circuit for noise removal, and thus the cost can be reduced.

Furthermore, in the noise filter 1 of this embodiment, as described above, the second and third impedance elements 3 and 4 having, in the frequency region higher than the predetermined frequency Fm, the impedance values Z2 and Z3 that are sufficiently higher than the impedance value Z1 of the first impedance element 2, respectively, are added between one end of the low-impedance first impedance element 2 having the transmission line structure and the first anode terminal 5 and between the other end of the first impedance element 2 and the second anode terminal 6, respectively. With this structure, the noise filter 1 can accomplish higher noise removal efficiency as compared with a noise filter formed only by the first impedance element 2.

Further, as will be described later in detail, the second and third impedance elements 3 and 4 can be formed integral with the first impedance element 2. Therefore, the noise filter can be very simple in structure as a whole, thereby enabling reduction in size, weight and cost.

Hereinbelow, description will be given about some more-detailed embodiments of noise filters according to the present invention.

First Embodiment

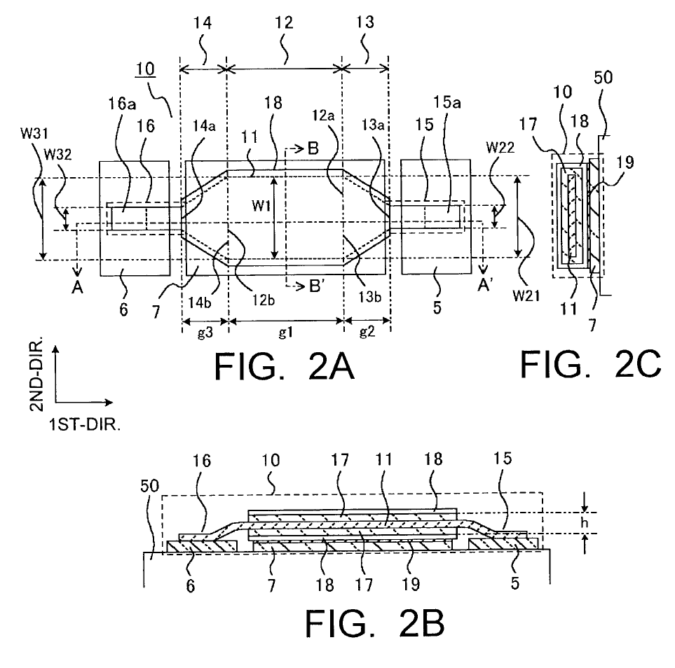

FIGS. 2A to 2C are diagrams showing a first embodiment of the present invention, in which FIG. 2A is an exemplary plan view, FIG. 2B is a sectional view taken along line A-A′ of FIG. 2A, and FIG. 2C is a sectional view taken along line B-B′ of FIG. 2A.

A noise filter 10 in this embodiment has a structure in which the first impedance element 2, the second impedance element 3 and the third impedance element 4 in FIG. 1 are unified together.

Referring to FIGS. 2A to 2C, the noise filter 10 comprises a metal plate 11 in the form of a substantially flat plate serving as a first conductor, a confronting metal layer 18 serving as a second conductor that confronts the metal plate 11 via a dielectric 17 interposed therebetween, a first anode terminal 5, a second anode terminal 6, and a cathode terminal 7.

A contact portion 15a of a first electrode portion 15 and a contact portion 16a of a second electrode portion 16 that form both end portions of the metal plate 11 in a longitudinal direction thereof, i.e. in a first direction, are respectively connected to the first anode terminal 5 and the second anode terminal 6 by, for example, welding. The confronting metal layer 18 and the cathode terminal 7 are connected together by means of a conductive adhesive 19. The first anode terminal 5, the second anode terminal 6 and the cathode terminal 7 are provided, for example, on a mounting board 50.

The metal plate 11 has a rectangular region 12 having a rectangular shape in plan view at a central portion thereof in the first direction. The rectangular region 12 has a length g1 in the first direction and a length W1 in a second direction perpendicular to the first direction.

A first trapezoidal region 13 having a trapezoidal shape in plan view is provided between a first one end 12a representing one end of the rectangular region 12 in the first direction and the first electrode portion 15, and a second trapezoidal region 14 having a trapezoidal shape in plan view is provided between a first other end 12b representing the other end of the rectangular region 12 in the first direction and the second electrode portion 16.

The first trapezoidal region 13 has a length g2 in the first direction. Lengths of the first trapezoidal region 13 in the second direction are such that a second one end 13a connected to the first electrode portion 15 has a length W22, and a second other end 13b connected to the first one end 12a of the rectangular region 12 has a length W21 (=W1).

The second trapezoidal region 14 has a length g3 in the first direction. Lengths of the second trapezoidal region 14 in the second direction are such that a third one end 14a connected to the second electrode portion 16 has a length W32, and a third other end 14b connected to the first other end 12b of the rectangular region 12 has a length W31 (=W1).

It is given that W22<W1 and W32<W1. Normally, g1>g2 and g1>g3.

In the foregoing structure, the rectangular region 12 forms a first impedance element having a transmission line structure with the metal plate 11 serving as a central conductor (first conductor) and with the confronting metal layer 18 serving as a cathode conductor (second conductor), the first trapezoidal region 13 forms a second impedance element having a first distributed constant circuit structure with the metal plate 11 serving as a central conductor (third conductor) and with the confronting metal layer 18 serving as a cathode conductor (fourth conductor), and further, the second trapezoidal region 14 forms a third impedance element having a second distributed constant circuit structure with the metal plate 11 serving as a central conductor (fifth conductor) and with the confronting metal layer 18 serving as a cathode conductor (sixth conductor).

As noted above, inasmuch as W22<W1 and W32<W1, a characteristic impedance Z01 of the first impedance element is smaller than each of a characteristic impedance Z02 of the second impedance element and a characteristic impedance Z03 of the third impedance element.

In the noise filter 10 of this embodiment, the first, second and third impedance elements may be formed by a solid electrolytic capacitor, an electric double-layer capacitor, a ceramic capacitor or the like.

Now, description will be given about determination of the structure of the first impedance element having the transmission line structure and removing most of noise.

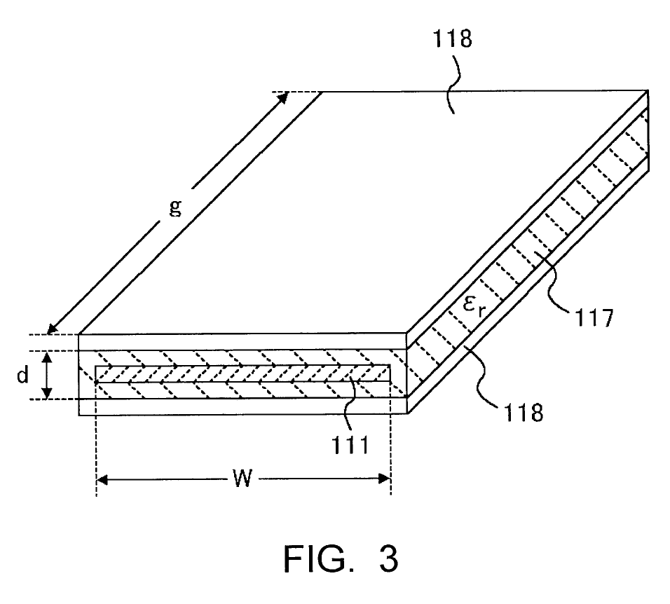

First, in a transmission line model having a structure in which an inside metal plate 111 is sandwiched between a pair of confronting metal layers 118 via a dielectric 117 as shown in FIG. 3, a capacitance C and an inductance L per unit length can be expressed as

C=4·ε₀·εᵣ·W/d

L=¼·μ₀·d/W

in which ε₀ represents a permittivity of free space, μ₀ represents a permeability of free space, and εᵣ and d represent a relative permittivity and a thickness of the dielectric, respectively.

Therefore, a characteristic impedance Z₀ of this transmission line model is given by

Z₀=(L/C)^{1/2}=¼·(d/W)·(μ₀/ε₀·εᵣ)^{1/2}.

Next, consideration will be given about a case in which the transmission line structure of the first impedance element is formed by an aluminum solid electrolytic capacitor, an electric double-layer capacitor or a ceramic capacitor.

In case of the transmission line structure of the aluminum solid electrolytic capacitor, an oxidized coating film is formed on aluminum whose surface area has been enlarged by etching.

On the other hand, the transmission line structure of the electric double-layer capacitor is formed at an interface between an activated carbon electrode surface and an electrolyte.

Each of them has a complicated shape. Accordingly, for the purpose of facilitating handling thereof, an equivalent relative permittivity is defined from a capacitance per unit length and an effective thickness.

Given that a capacitance per unit length is C, an effective thickness of the transmission line structure is h, and an equivalent relative permittivity is εᵤ,

C=4·ε₀·εᵤ·W/h

therefore

εᵤ=1/(4·ε₀)·C·h/W.

Here, in case of the general aluminum solid electrolytic capacitor as described above, a capacitance C per unit length, and an effective thickness h and width W of the transmission line structure (herein, an etched layer formed with an oxidized coating film) become

C=1.65×10⁻² (F/m)

h=1.5×10⁻⁴ (m)

W=1.0×10⁻² (m).

Therefore, given that a permittivity of free space ε₀ is 8.85×10⁻¹² (F/m), an equivalent relative permittivity εᵤ becomes 7.0×10⁶.

Similarly, in case of the general electric double-layer capacitor, a capacitance C per unit length, and an effective thickness h and width W of the transmission line structure (herein, a portion sandwiched between upper and lower collectors) become approximately

C=3.54×10¹ (F/m)

h=1×10⁻⁴ (m)

W=1×10⁻² (m).

Therefore, an equivalent relative permittivity εᵤ becomes 1.0×10¹⁰.

In case of the ceramic capacitor, assuming that the transmission line structure is made of a uniform ceramic material itself, an equivalent relative permittivity εᵤ is a relative permittivity itself of the ceramic material and becomes about 8.0×10³.

In the foregoing equation of the characteristic impedance, when the equivalent relative permittivity εᵤ of each capacitor is used as the relative permittivity εᵣ of the dielectric and the effective thickness h is used as the thickness d of the dielectric, the characteristic impedance is given by

Z₀=¼·(h/W)·(μ₀/ε₀·εᵤ)^{1/2}.

The characteristic impedance is preferably 0.1Ω or less for sufficiently removing electrical noise, and the condition for achieving the characteristic impedance of 0.1Ω or less is given by

W/h>2.5(μ₀/ε₀·εᵤ)^{1/2}.

By substituting 8.85×10⁻¹² (F/m) for ε₀, 1.26×10⁻⁶ (H/m) for μ₀, and the foregoing equivalent relative permittivity of each capacitor for εᵤ,

W/h>0.36 in case of the aluminum solid electrolytic capacitor,

W/h>0.009 in case of the electric double-layer capacitor, and

W/h>11 in case of the ceramic capacitor.

Further, a wavelength λ(m) in the transmission line structure can be calculated by the following equation when wavelength reduction due to the dielectric is taken into consideration.

λ=c/(f·εᵣ^{1/2})

in which c represents the speed of light (=3.0×10⁸ (m/s)), and f represents a frequency (Hz).

When a noise control frequency range generally required is set to 30 MHz to 1 GHz, a value of wavelength at 30 MHz where the wavelength becomes the longest is, when calculated using the equivalent relative permittivity εᵤ as the relative permittivity εᵣ,

3.8 mm in case of the aluminum solid electrolytic capacitor,

0.1 mm in case of the electric double-layer capacitor, and

112 mm in case of the ceramic capacitor.

Preferably, a length g of the transmission line structure in a longitudinal direction thereof is set to no less than a quarter of a wavelength for achieving sufficient attenuation. Accordingly, when applied to the transmission line structure of each capacitor, electrical noise can be removed over a wide frequency band by setting

g>0.95 mm in case of the aluminum solid electrolytic capacitor,

g>0.025 mm in case of the electric double-layer capacitor, and

g>28 mm in case of the ceramic capacitor.

Next, description will be given about a case in which the first, second and third impedance elements of the noise filter 10 are formed by an aluminum solid electrolytic capacitor.

In this case, aluminum foil is used as the metal plate 11, which has a predetermined thickness and a shape including the rectangular region 12, the first trapezoidal region 13 and the second trapezoidal region 14, and further including the first electrode portion 15 and the second electrode portion 16 at both ends thereof.

Ruggedness is formed by etching on both front and back surfaces of those portions corresponding to the rectangular region 12, the first trapezoidal region 13 and the second trapezoidal region 14, and an oxidized coating film is formed along such front and back surfaces as the dielectric 17.

Further, on surfaces of the oxidized coating film, a solid electrolyte layer such as a conductive high molecular layer, a graphite layer and a silver coating layer are formed in the order named as the confronting metal layer 18, and the silver coating layer and the cathode terminal 7 are bonded together using the conductive adhesive 19 such as silver paste.

The shape of the rectangular region 12 may be set depending on a desired characteristic thereof based on the foregoing structure determining principle.

Second Embodiment

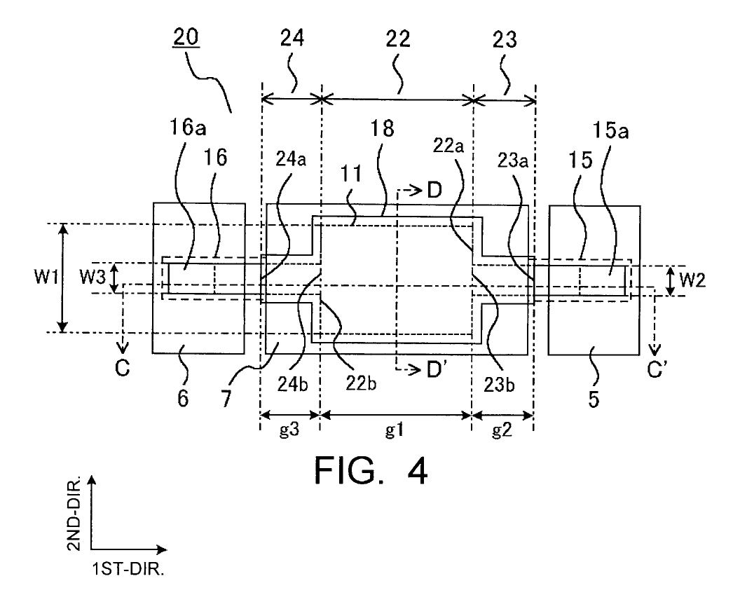

FIG. 4 is an exemplary plan view showing a structure of a second embodiment of the present invention. Although a sectional view taken along line C-C′ of FIG. 4 and a sectional view taken along line D-D′ of FIG. 4 are not given, those figures are the same as FIGS. 2B and 2C, respectively.

In the structure of this embodiment, only a metal plate 11 and a confronting metal layer 18 partly differ in shape as compared with the foregoing first embodiment. Accordingly, only such different portions will be described hereinbelow.

In a noise filter 20 of this embodiment, the metal plate 11 has a first rectangular region 22 having a rectangular shape in plan view at a central portion thereof in the first direction. A second rectangular region 23 having a rectangular shape in plan view is provided between a first one end 22a representing one end of the first rectangular region 22 in the first direction and a first electrode portion 15, and a third rectangular region 24 having a rectangular shape in plan view is provided between a first other end 22b representing the other end of the first rectangular region 22 in the first direction and a second electrode portion 16.

The first rectangular region 22 has a length g1 in the first direction and a length W1 in the second direction.

The second rectangular region 23 has a length g2 in the first direction and a length W2 (<W1) in the second direction. A second one end 23a and a second other end 23b in the first direction of the second rectangular region 23 are connected to the first electrode portion 15 and the first one end 22a of the first rectangular region 22, respectively.

The third rectangular region 24 has a length g3 in the first direction and a length W3 (<W1) in the second direction. A third one end 24a and a third other end 24b in the first direction of the third rectangular region 24 are connected to the second electrode portion 16 and the first other end 22b of the first rectangular region 22, respectively.

Also in this embodiment, the shape of the first rectangular region 22 may be set depending on a desired characteristic thereof based on the foregoing structure determining principle.

Third Embodiment

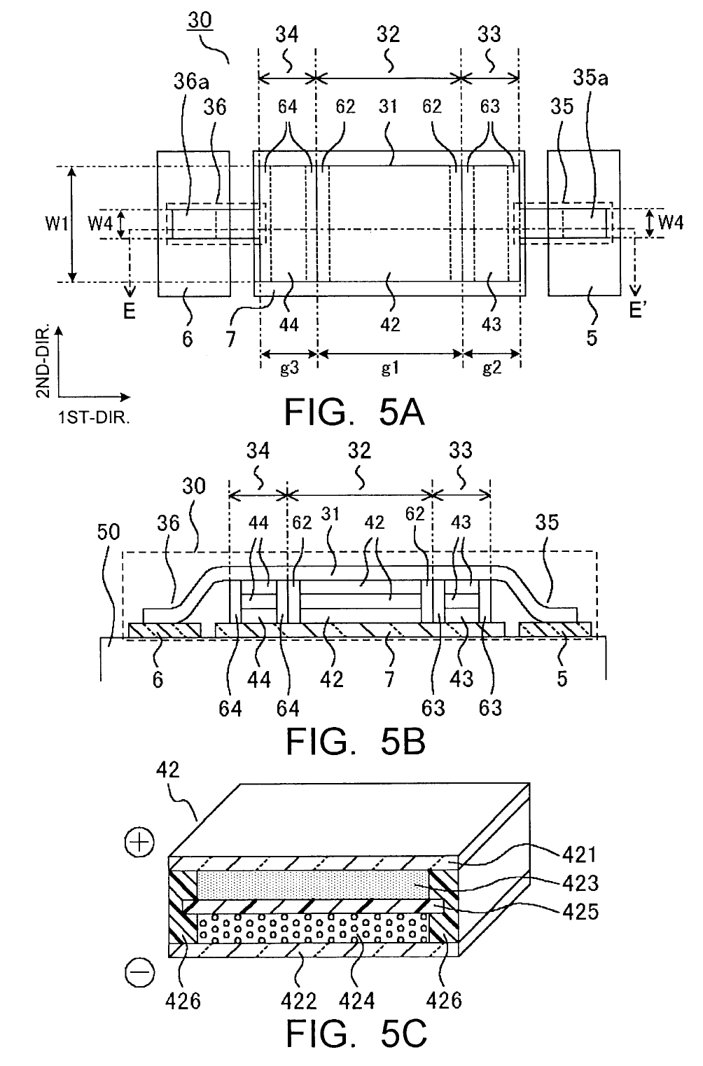

FIGS. 5A to 5C are diagrams showing a structure of a third embodiment of the present invention, in which FIG. 5A is an exemplary plan view, FIG. 5B is a sectional view taken along line E-E′ of FIG. 5A, and FIG. 5C is an exemplary sectional perspective view showing a structure of one electric double-layer cell included in an electric double-layer capacitor.

As shown in FIGS. 5A and 5B, in a noise filter 30 of this embodiment, the first, second and third impedance elements are formed by electric double-layer capacitors, respectively.

As the first, second and third impedance elements, a first capacitance portion 32, a second capacitance portion 33 and a third capacitance portion 34 each having a rectangular shape in plan view are used, respectively.

An anode side and a cathode side of each of the first, second and third capacitance portions 32, 33 and 34 are connected to a metal plate 31 and a cathode terminal 7, respectively.

A first electrode portion 35 and a second electrode portion 36 forming both end portions of the metal plate 31 in the first direction are respectively connected to a first anode terminal 5 and a second anode terminal 6.

Lengths g1, g2 and g3 of the first, second and third capacitance portions 32, 33 and 34 in the first direction satisfy g1>g2 and g1>g3.

In the noise filter 30, each capacitance portion forming a transmission line structure or a distributed constant circuit structure of the corresponding impedance element has a structure in which a plurality of electric double-layer cells are stacked within an insulating portion, so that the withstand voltage can be further increased.

Specifically, the first capacitance portion 32 forming the transmission line structure of the first impedance element has a structure in which a plurality of first electric double-layer cells 42 are stacked within an insulating portion 62. The second capacitance portion 33 forming the distributed constant circuit structure of the second impedance element has a structure in which a plurality of second electric double-layer cells 43 are stacked within an insulating portion 63. Further, the third capacitance portion 34 forming the distributed constant circuit structure of the third impedance element has a structure in which a plurality of third electric double-layer cells 44 are stacked within an insulating portion 64. This makes it possible to further increase the withstand voltage of the noise filter 30.

FIG. 5C is a sectional perspective view showing a schematic structure of an electric double-layer cell, using the first electric double-layer cell 42 as an example.

Referring to FIG. 5C, in the first electric double-layer cell 42, a pair of gaskets 426 are arranged in the first direction and collectors 421 and 422 disposed on upper ad lower sides of the gaskets 426 form an anode and a cathode, respectively. An electrolyte 423 contacting the collector 421 and an activated carbon electrode 424 contacting the collector 422 are provided so as to sandwich therebetween a separator 425 through which the electrolyte 423 is passable.

A structure of each of the second electric double-layer cell 43 and the third electric double-layer cell 44 is the same as the structure of the first electric double-layer cell 42, and thus illustration and explanation thereof are omitted herein.

In the noise filter 30, the shape in plan view of the second capacitance portion 33 or the third capacitance portion 34 may be the same as that of the portion corresponding to the second or third impedance element in the noise filter 10 or 20.

As described above, in the transmission line type noise filter of the present invention, between one end of the low-impedance first impedance element having the transmission line structure and the first anode terminal, and between the other end of the first impedance element and the second anode terminal, there are added the second and third impedance elements, respectively, that have the impedance values Z2 and Z3 sufficiently higher than the impedance value Z1 of the first impedance element. This makes it possible to realize the noise removal efficiency higher than that realized by a noise filter formed only by the first impedance element.

The present invention is not limited to the foregoing embodiments, but various changes may be made within a range of the gist thereof. For example, the second and third impedance elements are provided at both ends of the first impedance element in the foregoing embodiments, but it may also be configured that only one of the second and third impedance elements is provided.

Further, as the second and third impedance elements, inductance elements may be used instead of the capacitance elements.

Further, the first to third impedance elements may be formed individually rather than formed integral with each other and then assembled together, as long as the relationship among impedance values of the respective elements is satisfied, and further, a dc resistance between the first anode terminal and the second anode terminal is set to be sufficiently small (normally, 10 mΩ or less).

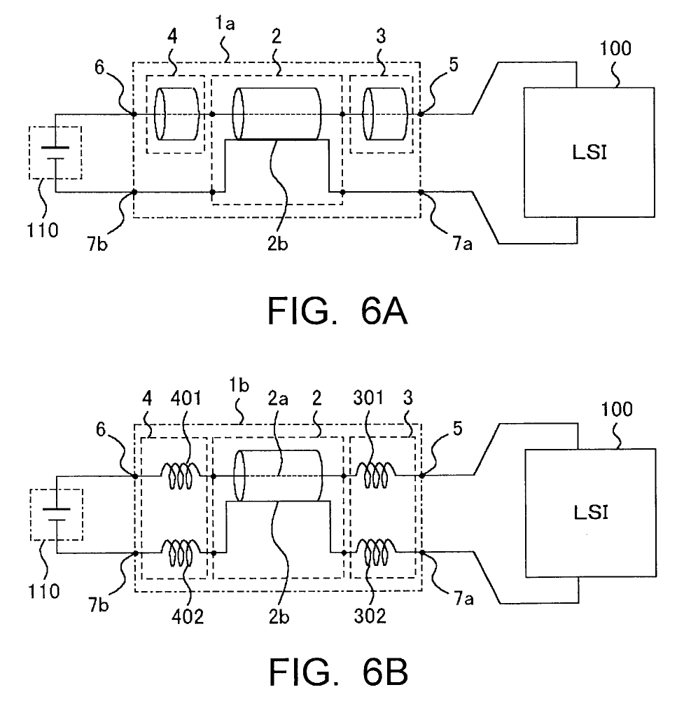

In the foregoing embodiments, the description has been given about the three-terminal structure having the first anode terminal, the second anode terminal and the cathode terminal. However, as shown in FIG. 6A, a four-terminal structure may be employed. Specifically, a first anode terminal 5 and a first cathode terminal 7a may be provided at one end of a noise filter 1a, while a second anode terminal 6 and a second cathode terminal 7b may be provided at the other end of the noise filter 1a.

In this event, at least a cathode conductor 2b of a first impedance element 2 is connected to the first cathode terminal 7a and the second cathode terminal 7b, and a dc resistance between the first cathode terminal 7a and the second cathode terminal 7b is set to be sufficiently small (normally, 10 mΩ or less).

Further, like a noise filter 1b of FIG. 6B having another four-terminal structure, it may be configured that an inductance element 301 and an inductance element 401 are connected between one end of a central conductor 2a of a first impedance element 2 and a first anode terminal 5 and between the other end of the central conductor 2a and a second anode terminal 6, respectively, and further, an inductance element 302 and an inductance element 402 are connected between one end of a cathode conductor 2b of the first impedance element 2 and a first cathode terminal 7a and between the other end of the cathode conductor 2b and a second cathode terminal 7b, respectively.

In this case, the inductance element 301 and the inductance element 302 serve as the second impedance element, while the inductance element 401 and the inductance element 402 serve as the third impedance element.

Further, the description has been given about the aluminum solid electrolytic capacitor as a solid electrolytic capacitor, but a tantalum solid electrolytic capacitor may be used instead of it.

In this case, referring to FIGS. 2A to 2C, a tantalum plate having a predetermined thickness and shape is used as a metal plate 11, and tantalum powder is press-molded on both front and back surfaces of those portions corresponding to a rectangular region 12, a first trapezoidal region 13 and a second trapezoidal region 14, then sintered to form a tantalum sintered body, and then a tantalum oxide coating film is formed along surfaces of the tantalum sintered body as a dielectric 17. Further, on surfaces of the tantalum oxide coating film, a solid electrolyte layer such as a conductive high molecular layer, a graphite layer and a silver coating layer are formed in the order named as a confronting metal layer 18, and the silver coating layer and a cathode terminal 7 are bonded together using a conductive adhesive 19 such as silver paste.

The tantalum sintered body may also be formed by forming a green sheet, from slurry including tantalum powder, having a predetermined thickness and a shape that covers the rectangular region 12, the first trapezoidal region 13 and the second trapezoidal region 14 of the metal plate 11, winding the green sheet so as to sandwich the rectangular region 12, the first trapezoidal region 13 and the second trapezoidal region 14 while exposing a first electrode portion 15 and a second electrode portion 16 at both ends of the metal plate 11, and sintering them.

While the present invention has thus far been described in conjunction with several embodiments thereof, it will readily be possible for those skilled in the art to put the present invention into practice in various other manners. For example, the noise filter according to the present invention can be connected to the LSI and packaged with the LSI in a common package so that an LSI chip having a noise filter is produced.

What is claimed is:

1. A transmission line type noise filter connectable between an electrical load component (100) and a power supply (110) for attenuating a coming alternating current while passing a coming direct current, said transmission line type noise filter comprising:
a first anode terminal (5) connected to said electrical load component;
a second anode terminal (6) connected to said power supply;
a first impedance element (2) having a transmission line structure; and
a second impedance element (3) having an impedance value greater than an impedance value of said first impedance element, and connected between one end of said first impedance element and said first anode terminal;
the other end of said first impedance element (2) being connected to said second anode terminal.

2. A transmission line type noise filter according to claim 1, wherein said second impedance element (3) is formed integral with said first impedance element (2).

3. A transmission line type noise filter according to claim 1, further comprising a third impedance element (4) having an impedance value greater than the impedance value of said first impedance element (2), and interposingly connected between said other end of said first impedance element and said second anode terminal (6).

4. A transmission line type noise filter according to claim 3, wherein said third impedance element (4) is formed integral with said first impedance element (2).

5. A transmission line type noise filter connectable between an electrical load component and a power supply for attenuating a coming alternating current while passing a coming direct current, said transmission line type noise filter comprising:
a first anode terminal (5) connected to said electrical load component;
a second anode terminal (6) connected to said power supply;
a first impedance element (12) having a transmission line structure;
a second impedance element (13) having an impedance value greater than an impedance value of said first impedance element, and connected between one end of said first impedance element and said first anode terminal; and
a cathode terminal (7) connected to a fixed potential;
the other end of said first impedance element (12) being connected to said second anode terminal;
said first impedance element comprising a first conductor (11) and a second conductor (18) confronting said first conductor;
said transmission line structure being formed in a region where said first conductor and said second conductor are disposed confronting each other, and has a rectangular shape in plan view, and a length (g1) of said first conductor in a first direction parallel to a line of said transmission line structure, a length (W1) of said first conductor in a second direction perpendicular to said first direction, and an effective thickness (h1) are set so that the impedance value of said first impedance element becomes smaller than the impedance value of said second impedance element;
one end of said first conductor in said first direction being connected to said second impedance element, while the other end thereof being connected to said second anode terminal;
said second conductor being connected to said cathode terminal.

6. A transmission line type noise filter according to claim 5, wherein said second impedance element comprises a third conductor (11) and a fourth conductor (18) confronting said third conductor, and has a first distributed constant circuit structure formed in a region where said third conductor and said fourth conductor are disposed confronting each other;
one end of said third conductor in said first direction being connected to said first conductor, while the other end thereof being connected to said first anode terminal;
said fourth conductor is connected to said cathode terminal; and
a shape in plan view and an effective thickness of said first distributed constant circuit structure are set so that the impedance value of said second impedance element becomes greater than the impedance value of said first impedance element.

7. A transmission line type noise filter according to claim 6, wherein said first distributed constant circuit structure has a rectangular shape in plan view, and a length (g2) of said third conductor in said first direction, a length (W2 (<W1)) of said third conductor in said second direction, and an effective thickness (h2) are set so that the impedance value of said second impedance element becomes greater than the impedance value of said first impedance element.

8. A transmission line type noise filter according to claim 6, wherein said first distributed constant circuit structure has a trapezoidal shape in plan view, and a length (g2) of said third conductor in said first direction, a length (W21 (≦W1)) in said second direction of said one end of said third conductor in said first direction, a length (W22 (<W21)) in said second direction of said other end of said third conductor in said first direction, and an effective thickness (h2) are set so that the impedance value of said second impedance element becomes greater than the impedance value of said first impedance element.

9. A transmission line type noise filter according to claim 8, wherein the length (W21) in said second direction of said one end of said third conductor is equal to the length (W1) in said second direction of said first conductor.

10. A transmission line type noise filter according to claim 5, further comprising a third impedance element (14) having an impedance value greater than the impedance value of said first impedance element, and interposingly connected between said other end of said first impedance element and said second anode terminal (6);
the other end in said first direction of said first conductor of said first impedance element being connected to said third impedance element.

11. A transmission line type noise filter according to claim 10, wherein said third impedance element comprises a fifth conductor (11) and a sixth conductor (18) confronting said fifth conductor, and has a second distributed constant circuit structure formed in a region where said fifth conductor and said sixth conductor are disposed confronting each other;
one end of said fifth conductor in said first direction being connected to said first conductor, while the other end thereof being connected to said second anode terminal;
said sixth conductor is connected to said cathode terminal; and
a shape in plan view and an effective thickness of said second distributed constant circuit structure are set so that the impedance value of said third impedance element becomes greater than the impedance value of said first impedance element.

12. A transmission line type noise filter according to claim 11, wherein said second distributed constant circuit structure has a rectangular shape in plan view, and a length (g3) of said fifth conductor in said first direction, a length (W3 (<W1)) of said fifth conductor in said second direction, and an effective thickness (h3) are set so that the impedance value of said third impedance element becomes greater than the impedance value of said first impedance element.

13. A transmission line type noise filter according to claim 11, wherein said second distributed constant circuit structure has a trapezoidal shape in plan view, and a length (g3) of said fifth conductor in said first direction, a length (W31 (≦W1)) in said second direction of said one end of said fifth conductor in said first direction, a length (W32 (<W31)) in said second direction of said other end of said fifth conductor in said first direction, and an effective thickness (h3) are set so that the impedance value of said third impedance element becomes greater than the impedance value of said first impedance element.

14. A transmission line type noise filter according to claim 13, wherein the length (W31) in said second direction of said one end of said fifth conductor is equal to the length (W1) in said second direction of said first conductor.

15. A transmission line type noise filter according to claim 8, wherein at least one of said third and fifth conductors is formed integral with said first conductor.

16. A transmission line type noise filter according to claim 5, wherein the length (g1) of said first impedance element in said first direction is set to no less than a quarter of a wavelength of high-frequency current generated from said electrical load component.

17. A transmission line type noise filter according to claim 5, wherein a ratio between the length (W1) of said first impedance element in said second direction and said effective thickness (h1) is set so that a characteristic impedance of said transmission line type noise filter in a transmission line model becomes 0.1Ω or less.

18. A transmission line type noise filter according to claim 5, wherein said transmission line structure is formed by a solid electrolytic capacitor.

19. A transmission line type noise filter according to claim 5, wherein said transmission line structure is formed by an electric double-layer capacitor.

20. A transmission line type noise filter according to claim 18, wherein said solid electrolytic capacitor is an aluminum solid electrolytic capacitor, and a ratio between the length (W1) of said first impedance element in said second direction and said effective thickness (h1) is set greater than 0.36.

21. A transmission line type noise filter according to claim 19, wherein a ratio between the length (W1) of said first impedance element in said second direction and said effective thickness (h1) is set greater than 0.009.
